(19) United States
(12) Patent Application Publication
(10) Pub. No.: US 2016/0069721 A1
(43) Pub. Date: Mar. 10, 2016

(54) PORTING CONFIGURATION FOR A FLUID FLOW METER

(71) Applicant: Great Plains Industries, Inc., Wichita, KS (US)

(72) Inventors: Victor V. Lukic, Wichita, KS (US); Jeffrey J. Williams, Bel Aire, KS (US)

(21) Appl. No.: 14/481,645

(22) Filed: Sep. 9, 2014

(51) Int. Cl. G01F 3/10

(52) U.S. Cl. CPC G01F 3/10

(57) ABSTRACT

A flow meter configuration with improved inlet and outlet porting for improving the Turndown Ratio including a chamber having opposed arcuate chamber walls and a central axis extending therethrough, at least one gear for rotation within the chamber wherein the at least one gear is positioned to seal against a chamber wall during rotation, an inlet in fluid communication with the chamber, the inlet including an inlet wall, an outlet in fluid communication with said chamber, the outlet including an outlet wall, and wherein at least one of the inlet wall and outlet wall is angled relative to the central axis so as to form a porting angle less than 90°. In some embodiments, the opposed arcuate chamber walls may lie on an arc of less than 180°.

### TECHNICAL FIELD OF THE INVENTION

The present invention relates to a fluid flow meter, and more particularly, but not by way of limitation, to port configurations that improve a flow meter's usable operational flow range.

### BACKGROUND OF THE INVENTION

Flow measurement is the quantification of bulk fluid movement. Positive-displacement flow meters measure fluid by dividing a flow of fluid into fixed, metered volumes, and then counting the number of times the volume is filled and released. The general operation of an exemplary prior art flow meter 1 is illustrated in prior art FIGS. 1A-1D. To pass through flow meter 1, fluid flow enters the flow meter through inlet port 5, flows through chamber 3 as will be hereinafter described, and exits through outlet port 10. Typically, specially shaped gears are housed within chamber 3 formed within the flow meter and are used to separate the liquid flow into precise volumes. As shown in FIGS. 1A-1D, the gears 15, 20 are generally elliptical in shape. As can be seen in FIGS. 1A-1D, despite rotation of the gears 15, 20, their generally elliptical shape allows them to continuously mesh with one another to form a seal and prevent fluid from flowing therebetween. Additionally, as the gears 15, 20 rotate within the chamber, they also seal against the inner chamber walls 25, 30 at one or more points. As shown in FIG. 1A, gear 15 seals against inner chamber wall 25 at a single point 35, whereas gear 20 seals against inner chamber wall 30 at two points (both labeled 40). The position of gears 15, 20 in FIG. 1A creates three different zones: inlet zone 45 which is in communication with inlet 5; outlet zone 50 which is in communication with outlet 10, and pocket zone 55 which is sealed off from both the inlet 5 and outlet 10 by gear 20 at seal points 40.

FIG. 1B illustrates the gears 15, 20 as having been rotated by about 45 degrees. As can be seen, both the gears 15, 20 now only seal against their respective inner chamber walls 25, 30 at a single point 35, 40. Only the inlet zone 45 and the outlet zone 50 are present in FIG. 1B. Rotation of gear 20 has opened the pocket zone 55 (from FIG. 1A) allowing the fluid contained therein to reach the outlet 10.

In FIG. 1C, the gears 15, 20 have again been rotated by about another 45 degrees. Now, gear 20 seals against inner chamber wall 30 at a single point 40, whereas gear 15 seals against inner chamber wall 25 at two points (both labeled 35) creating a new and different pocket zone 55 as compared to FIG. 1A.

FIG. 1D illustrates gears 15, 20 as having been rotated by yet another 45 degrees. Both the gears 15, 20 again seal only against their respective inner chamber walls 25, 30 at a single point 35, 40. As with FIG. 1B, only the inlet zone 45 and the outlet zone 50 are present in FIG. 1D. Rotation of gear 15 has opened the pocket zone 55 (from FIG. 1C) allowing the fluid contained therein to reach the outlet 10. However, as the flow of liquid causes rotation of the gears 15, 20 within the flow meter 1, a decrease in pressure from the inlet 5 to the outlet 10 also occurs.

In conventional flow meter 1, with each full rotation of the gears 15, 20, two pocket zones 55 of fluid are created (one by gear 15, and one by gear 20) and then released. Fluid from inlet 5 moves from inlet zone 45 and is captured in each such pocket zone 55 as described above, and the fluid is then released into outlet zone 50 to flow out through outlet 10. The fluid captured in pocket zone 55 is referred to herein as a pocket of fluid. The volume of a pocket of fluid is known, and the number of pockets of fluid passed through flow meter 1 with each rotation of gears 15, 20 is also known. Thus, by monitoring the total number of rotations of gears 15, 20, the total amount of fluid passing through flow meter 1 can be determined.

Prior art FIG. 2 illustrates the structure of an example prior art flow meter 1 in which the gears have been removed from chamber 3 for ease of reference. As can be seen, inner wall 25 is the inner wall of chamber wall 60 and inner wall 30 is the inner wall of chamber wall 65. Inlet 5 is formed by one or more inlet walls 70, and outlet 10 is formed by one or more outlet walls 80. In prior art flow meter 1, the chamber walls 60, 65 generally extend over an arc B1, which is generally 180 degrees. At their respective two opposite ends, chamber walls 60, 65 meet with inlet and outlet walls 70, 80 and generally from 90 degree angles.

Additionally, gears having shapes other than ellipses are also known in the art. For example, a so-called tri-gear is shown in Australian Patent Application No, AU 2012100424 B4, Chinese Patent Application No. CN 101413818A, and Japanese Patent Application No. JP 60166775A. In each of these references, two gears each having three prongs or lobes are used in flow meters with standard inner chamber walls. The pocket zones which are created with tri-gears may be somewhat smaller than those created with elliptical gears, but a single rotation of the gears when using tri-gears creates more pocket zones per rotation of the gears as compared to using elliptical gears.

When creating positive displacement flow meters, manufacturers generally begin by determining the minimum flow rate (i.e., GPM—gallons per minute, L/min—liters per minute, etc.) at which the flow meter will accurately gauge flow rate. Generally, at the minimum flow rate, the pressure drop from the inlet to the outlet is fairly minimal, if it is detectable at all. The flow rate is then increased, which causes an increase in the pressure drop across the flow meter. The pressure drop is monitored across the flow meter until the point at which the pressure drop reaches about 1 Bar, or 14.5 psi. Above about 1 Bar of pressure drop, the flow meter itself may be damaged, and/or the accuracy with which it gauges liquid flow may be decreased. The flow rate at which the pressure drop is about 1 Bar is considered the maximum flow rate for the flow meter. The ratio of the maximum and minimum flow rates of the flow meter is called the Turndown Ratio of the flow meter. Larger Turndown Ratios imply larger ranges of fluid flow rate which can pass through the flow meter and which can be accurately determined without damaging the flow meter. As will be understood, larger Turndown Ratios are desirable.

### BRIEF DESCRIPTION OF THE INVENTION

An embodiment of the present invention is a flow meter with improved Turndown Ratio including a chamber, an inlet, an outlet, at least one rotor gear that lies in the chamber, and a central axis that passes through the inlet and the outlet. In this embodiment, the inlet intersects the chamber on one side of the chamber and the inlet space expands as it approaches the chamber, and further, the outlet intersects the chamber on an opposing side of the chamber and the outlet space likewise expands as it approaches the chamber.

Another embodiment of the present invention is a flow meter with improved Turndown Ratio including a chamber, an inlet that communicates with the chamber, an outlet that communicates with the chamber, a first rotor gear and a second rotor gear that lie in the chamber, and a central axis that passes through the inlet and the outlet. The communication between the inlet and the chamber forms an acute angle as measured by the central axis and the line of intersection of the inlet wall with the chamber wall. Similarly, the communication between the outlet and the chamber forms an acute angle as measured by the central axis and the line of intersection of the outlet wall with the chamber wall.

Another embodiment of the present invention is a flow meter having a chamber with opposed arcuate chamber walls, the chamber walls having a central axis, an inlet in fluid communication with the chamber, an outlet in fluid communication with the chamber, at least one gear for rotation within the chamber wherein the at least one gear is positioned to seal against a chamber wall during rotation, and wherein at least one of the inlet wall and outlet wall is angled relative to the central axis. Stated another way, the at least one inlet and outlet can be conically shaped such that it widens from a proximal portion to a distal portion, wherein the distal portion is in communication with the chamber. It is also recognized and anticipated that the inlet wall and outlet wall can have a different angle or different conical shape compared to each other.

Further, in terms of implementing the above embodiments, a tri-gear design would allow the opposed chamber walls to be reduced to an arcuate length or circumference spanning 120° —the tri-gears widest seal points are 120° apart. This reduces the amount of expensive part manufacturing and opens up needed area of the inlet and outlet for more gradual fluid movement. The opened area allows for designs, such as a funnel or tapered conical design at a port, to minimize the pressure drop through the chamber. Testing has confirmed improved accuracy and lower pressure drops when the fluid is allowed to “funnel”. The tri-gear design allows for better inlet/outlet porting.

Thus, the tri-gear design is not necessarily better than the oval gear design, but because the tri-gear requires only an arcuate length spanning 120° on each side of the chamber for effective sealing as opposed to an arcuate length spanning 180° on each side of the chamber when oval or elliptical gears are used, the design allows for better inlet/outlet porting. Nonetheless, even at the 180° chamber wall configuration, the chamber can be designed with at least one port having a conformation, preferably a funnel or conical design that would allow for reduced pressure drop.

### BRIEF DESCRIPTION OF THE DRAWINGS

FIGS. 1A-1D illustrate cross sectional views of a prior art flow meter with elliptical gears as the gears rotate through four different positions.

FIG. 2 illustrates a cross sectional view of a prior art flow meter in which the gears have been removed.

FIG. 3 illustrates a cross sectional view of an example embodiment of a flow meter constructed in accordance with the teachings of the present invention in which the gears have been removed.

FIG. 4A illustrates a cross sectional view of a second example embodiment of a flow meter constructed in accordance with the teachings of the present in which the gears have been removed.

FIG. 4B illustrates a cross sectional view of the second example embodiment shown in FIG. 4A with the gears in place.

FIG. 5 illustrates a pressure diagram for the prior art flow meter of FIG. 2.

FIG. 6 illustrates a pressure diagram for the example flow meter embodiment of FIG. 3.

FIG. 7 illustrates a pressure diagram for the second example flow meter embodiment of FIG. 4.

FIG. 8A illustrates a generalized diagram of a flow meter.

FIG. 8B illustrates a chart of percentage decreases in pressure as angles A and B of the structure in FIG. 8A are modified.

### DETAILED DESCRIPTION OF THE INVENTION

The present invention is described in detail herein, and it is disclosed in a manner that is understandable to a person skilled in the art. Aspects of the invention may be practiced without the implementation of some of the described features. It should be understood that some details have not been discussed deeply in order to provide a clear focus of the invention.

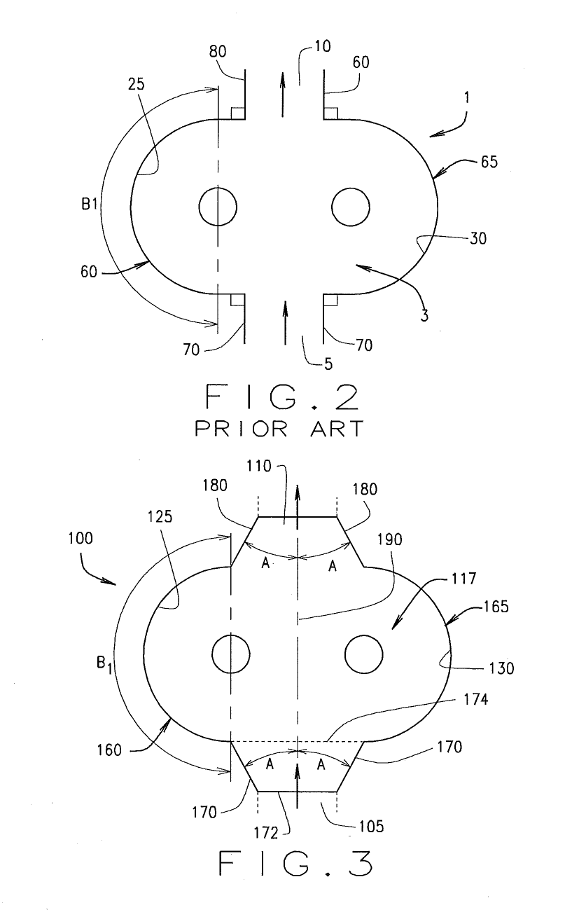

According to one example embodiment of the present invention, a flow meter 100 as shown in FIG. 3 may include an inlet 105, and an outlet 110 and a chamber 117 therebetween. Inlet walls 170 are preferably angled or tapered at a porting angle A, relative to a central axis 190 of the flow meter 100. Specifically, inlet walls 170 may have a generally conical shape, expanding from a distal portion 172 to a proximal portion 174. The may be said for outlet walls 180 as well. Like the chamber walls 60, 65 of a prior art flow meter 1 as shown in FIG. 2, the chamber walls 160, 165 of flow meter 100 preferably extend over the same angle B1, which is a 180° half-circular arcuate section as shown in FIG. 3. Inner walls 125, 130 of chamber walls 160, 165 are therefore substantially the same as inner walls 25, 30 of prior art flow meter 1. However, due to the porting angle A at which the inlet walls 170 and outlet walls 180 are positioned, the chamber walls 160, 165 also meet the inlet and outlet walls 170, 180 at an oblique angle. Preferably, angle A is less than about 90°, and more preferable they are less than about 45°, and most preferably less than about 30°. In addition, in other embodiments, the point of intersection between chamber walls 160, 165 and the inlet and outlet walls 170, 180 may be rounded, rather than sharp as shown in FIG. 3. Adding an angle A to at least one inlet or outlet wall 170, 180 wherein angle A is less than 90° may also be referred to herein as a porting angle.

Since flow meter 100 includes chamber walls 160, 165 which extend in essentially a half-circle over 180 degrees (angle B1), flow meter 100 may be used with both elliptical gears and tri-gears, or any other known gear shapes which have been used with prior art flow meters similar to that shown in FIG. 2.

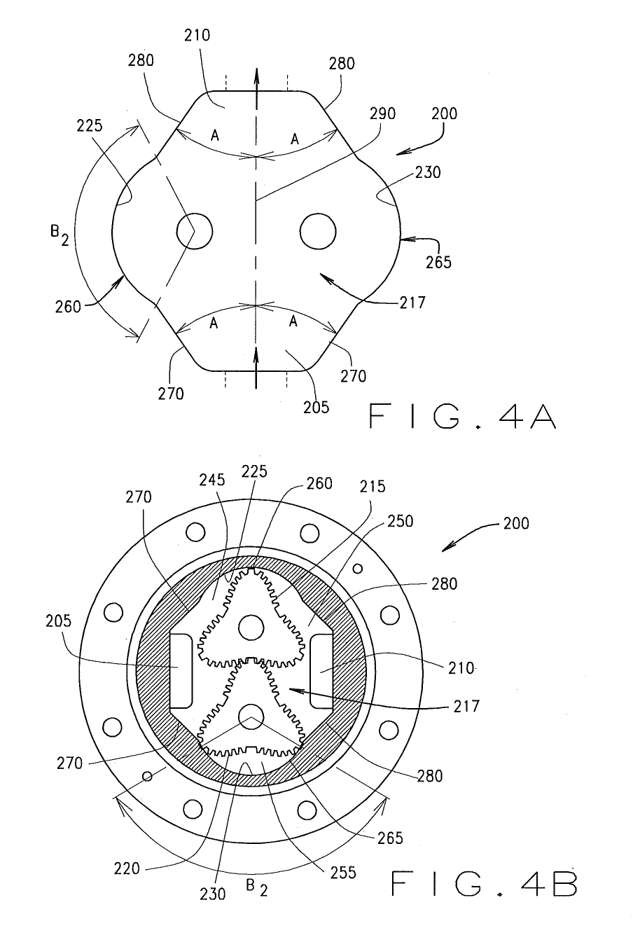

In a second exemplary embodiment illustrated in FIG. 4A, a flow meter 200 includes chamber 217 having chamber walls 260, 265 (and thus inner walls 225, 230) which extend over a smaller arc B2, which is preferably at least about 120 degrees. In this embodiment, inlet chamber walls 270 and outlet chamber walls 280 are again preferably angled or conically tapered with respect to the central axis 290 at a porting angle A. Thus, inlet and outlet walls 270, 280 again meet the chamber walls 260, 265 at an oblique angle. As above, angle A is preferably less than about 90°, and more preferable they are less than about 45°, and most preferably less than about 30°. As shown in FIG. 4A, the intersection between inlet and outlet walls 270, 280 and chamber walls 260, 265 are generally rounded. It is noted that these intersections could be sharp, or could be otherwise modified.

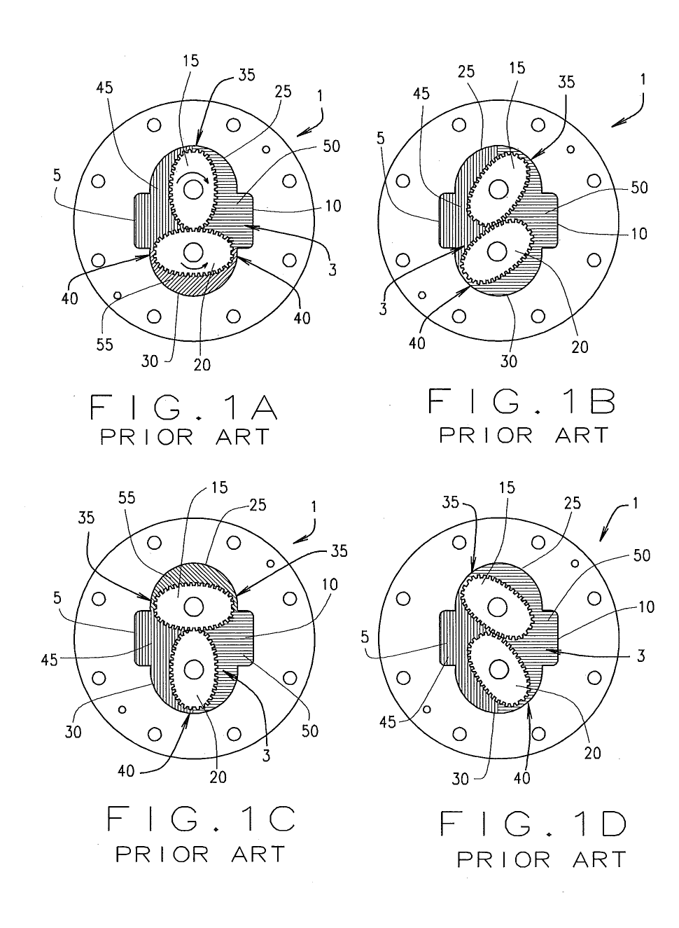

In contrast to flow meter 100 shown in FIG. 3, flow meter 200 would not be used with prior art elliptical gears. The chamber walls 260, 265 do not extend in a sufficiently large arc, and therefore would not allow an elliptical gear to seal against both inner chamber walls 225, 230 at the same time. Therefore, an elliptical gear could not create a pocket zone in flow meter 200, in which chamber walls 260, 265 extend in an arc of approximately 120 degrees or more, but less than about 180 degrees. However, as shown in FIG. 4B, a tri-gear (or gears of certain other shapes as would be understood by a person of ordinary skill in the art) could still be used with flow meter 200. As can be seen, tri-gears 215, 220 generally have three apexes spaced about 120 degrees apart, such that a tri-gear 215, 220 could seal with both inner chamber walls 225, 230 at the same time, thereby creating a pocket zone 255. The angle at which the inlet walls 270 extend from inlet 205 and intersect with chamber walls 260, 265 creates a larger inlet zone 245 as compared to a prior art inlet zone 45 shown in FIGS. 1A-1D. Similarly, the angle at which the outlet walls 280 extend from outlet 210 and intersect with chamber walls 260, 265 creates a larger outlet zone 250 as compared to a prior art outlet zone 50 shown in FIGS. 1A-1D.

The utilization of tri-gears allows a clearance pocket of at least about 120 degrees and less than 180 degrees, and thereby allows less critical machining. This lowers the overall cost to produce a flow meter 200. Further, as noted above, in flow meters 100 and 200, the porting angle A of the inlet and outlet walls 170, 180, 270, 280 creates a larger inlet and outlet zone, which lowers the pressure drop across the flow meters 100, 200. Thus, there is less stress put on the gears from the incoming fluid.

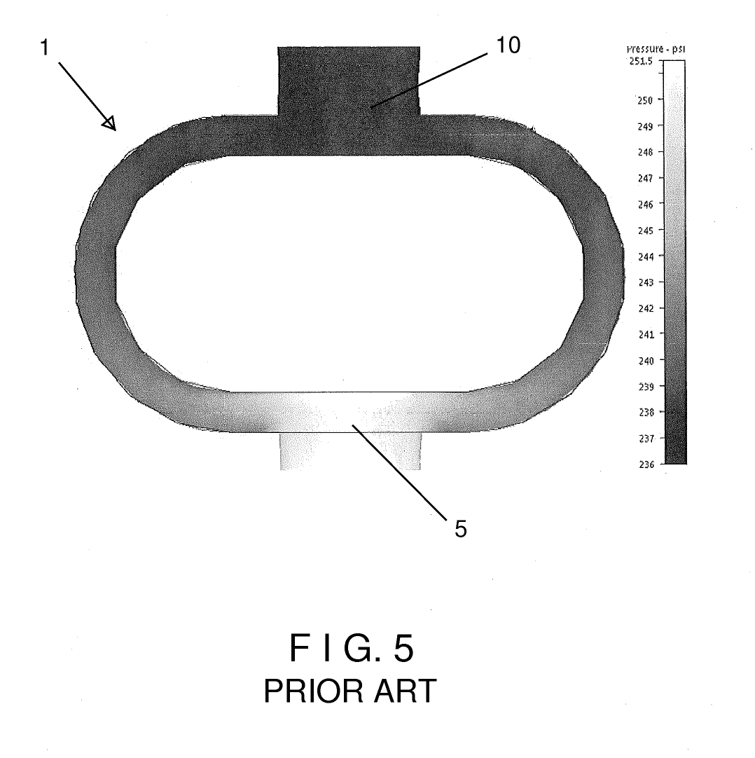

Both flow meter constructions 100, 200 show measurable improvement in performance, as can be seen in FIGS. 5-7. Flow meters 100, 200 have better Turndown Ratios than prior art flow meter 1. It has been discovered that by altering the inlet 5 and outlet structure 10, and/or the arc B2 of chamber walls 260, 265, maximum flow rate can be increased with respect to the minimum flow rate, thereby increasing the Turndown Ratio.

FIG. 5 illustrates a pressure diagram for the prior art flow meter 1 of FIG. 2, with 20 wt. oil flowing through the meter 1 at 50 GPM. As can be seen, the pressure at the inlet 5 is approximately 251.5 psi, and the pressure at the outlet 10 is about 236 psi. Thus, a pressure drop of 251.5−236=14.5 psi=1 Bar is seen across the flow meter 1. 50 GPM is therefore the maximum flow rate of flow meter 1. Flow meter 1 has a minimum flow rate of about 5 GPM, which results in a fairly typical Turndown Ratio of 10:1, and a usable flow range of 5 to 50 GPM.

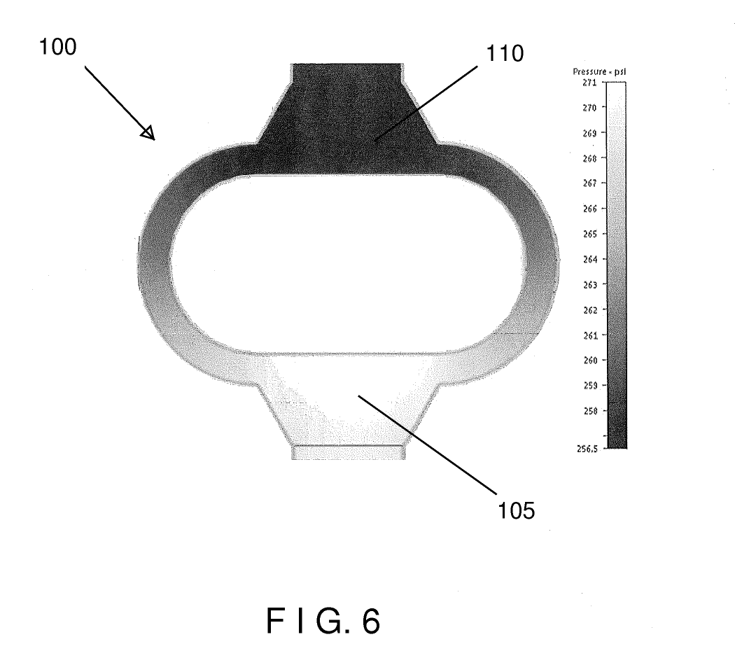

FIG. 6 illustrates a pressure diagram for flow meter 100 of FIG. 3, again with 20 wt. oil flowing through the meter 100 at 55 GPM. As can be seen, the pressure at the inlet 105 is approximately 271 psi, and the pressure at the outlet 110 is about 256.5 psi. Thus, a pressure drop of 271−256.5=14.5 psi=1 Bar is seen across the flow meter 100. 55 GPM is therefore the maximum flow rate of flow meter 100. Flow meter 100 has the same 5 GPM minimum flow rate as flow meter 1, which results in an improved turndown ratio of 11:1, and a usable flow range of 5 to 55 GPM. This is a flow rate improvement of about 10% as compared to the prior art flow meter 1.

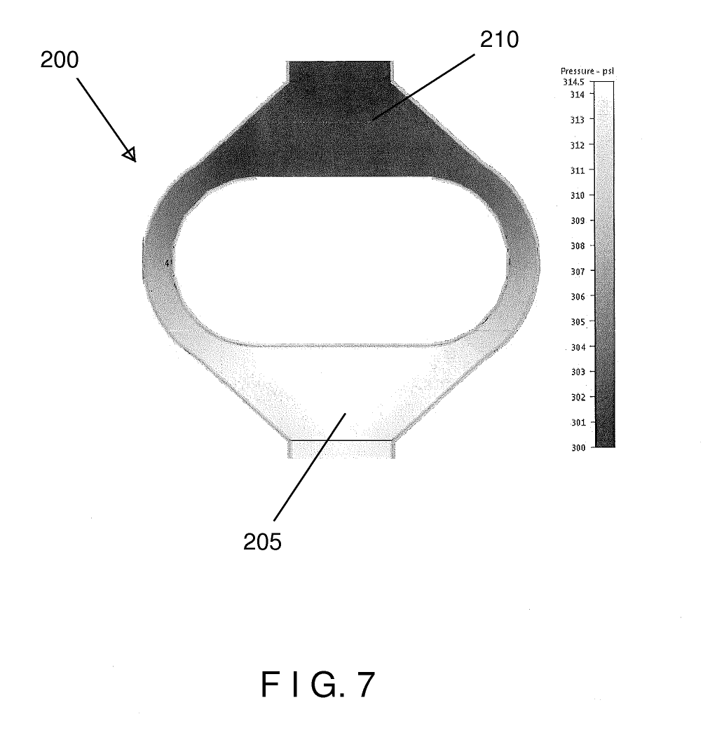

FIG. 7 illustrates a pressure diagram for flow meter 200 of FIGS. 4A and B, again with 20 wt. oil flowing through meter 200 at 60 GPM. As can be seen, the pressure at the inlet 205 is about 314.5 psi, and the pressure at the outlet 210 is about 300 psi. Thus, a pressure drop of 314.5−300=14.5 psi=1 Bar is seen across the flow meter 200. 60 GPM is therefore the maximum flow rate of flow meter 200. Again, flow meter 200 has the same 5 GPM minimum flow rate as flow meters 1, which results in an improved Turndown Ratio of 12:1, and a usable flow range of 5 to 60 GPM. This is a flow rate improvement of about 20% as compared to the prior art flow meter 1.

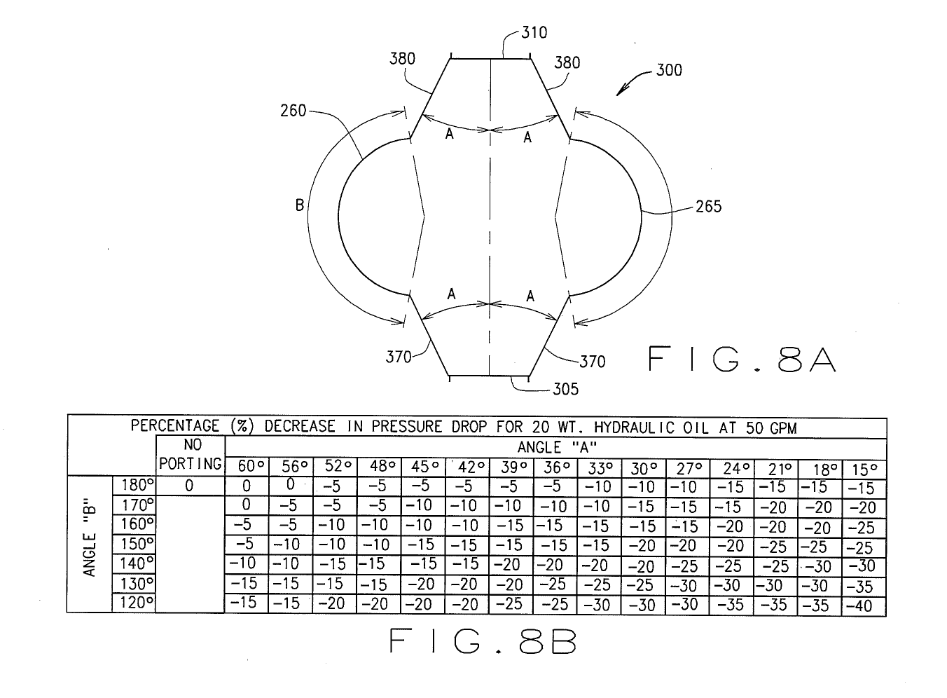

FIG. 8A illustrates a generalized flow meter 300 without any specific angle measurements. Instead, the porting angle of inlet and outlet walls 370, 380 is merely labeled A, while the arc of chamber walls 260, 265 is merely labeled B. The table in FIG. 8B provides measured percentage decreases in pressure drop for 20 wt. hydraulic oil flowing through flow meter 300 at 50 GPM, at various angles A and at various arcs B. As can be seen, the lowest percentage decreases in pressure drop is seen at a porting angle A of 60 degrees and a full 180 degree chamber arc B. However, the largest percentage pressure decrease is seen at a chamber arc B of 120 degree, and only a 15 degree porting angle A. The table in FIG. 8B may have an error margin of ±2.5%. Thus, various combinations of porting angles and chamber wall arcs are envisioned.

It is also recognized and anticipated that improved Turndown Ratios may also be achieved by simply changing the porting angle associated with either the meter inlet or outlet and not both. Although this configuration will not be as good as modifying both the inlet and the outlet, it will still produce improvement in the Turndown Ratio as compared to the prior art flow meter 1 discussed above.

The improved porting configuration disclosed herein can likewise be described as a flow meter including a chamber having opposed arcuate chamber walls, the chamber having a central access, at least one gear for rotation within the chamber wherein the at least one gear is positioned to seal against a chamber wall during rotation, an inlet in fluid communication with the chamber, an outlet in fluid communication with the chamber, and wherein at least one of the inlet wall and outlet wall is angled or tapered relative to the central axis. This angularity or taper can also be described as a conically shaped or funnel-shaped inlet and outlet such that the conically shaped inlet and/or outlet widens as it approaches the chamber, namely, such that it widens from a proximal portion to a distal portion, the distal portion being in communication with the chamber. It is also recognized and anticipated that the porting angle, taper or conically shaped inlet and outlet associated with a particular flow meter could have different porting angles associated respectively therewith. That is, the porting angle associated with the flow meter inlet may be different from the porting angle associated with the flow meter outlet. All of these scenarios produce a Turndown Ratio which is better than the Turndown Ratio associated with prior art flow meter 1.

Also, importantly, as disclosed in FIGS. 8A and 8B, it is recognized and anticipated that both the porting angle A and the chamber wall arc B can both vary in a particular flow meter configuration as discussed above so as to achieve an improved Turndown Ratio. Porting angle A can vary between a range from about 15° to less than 90°, and the chamber wall arc B can vary from approximately 120° to 180° as described above. It is also recognized and anticipated that ranges less than 120° may likewise be utilized to achieve improved Turndown Ratios. Other changes and modifications are likewise anticipated and envisioned.

Although the invention has been explained with respect to an embodiment, it is to be understood that many other possible modifications and variations can be made without departing from the spirit and scope of the invention as herein described.

Moreover, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed structures will be incorporated into such future embodiments. In sum, it should be understood that the invention is capable of modification and variation and is limited only by the following claims.

Lastly, all defined terms used in the application are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary is made herein. In particular, use of the singular articles such as “a,” “the,” “said,” and so forth should be read to recite one or more of the indicated elements unless a claim recites an explicit limitation to the contrary.

1. A flow meter comprising:
a chamber having opposed arcuate chamber walls, said chamber having a central axis;
at least one gear for rotation within said chamber, wherein said at least one gear is positioned to seal against a chamber wall during rotation;
an inlet in fluid communication with said chamber, said inlet including an inlet wall;
an outlet in fluid communication with said chamber, said outlet including an outlet wall;
wherein at least one of said inlet wall and outlet wall is angled relative to said central axis;

2. The flow meter of claim 1 wherein at least one of said inlet and outlet has a generally circular cross sectional shape, such that the angling of at least one of said inlet wall and outlet wall forms a generally conical shape.

3. The flow meter of claim 1 wherein said angle is between about 60 degrees and 15 degrees.

4. The flow meter of claim 1 wherein said opposed arcuate chamber walls have less than a 180 degree arc length.

5. The flow meter of claim 1 wherein said opposed arcuate chamber walls have about a 120 degree arc length.

6. The flow meter of claim 1 wherein said opposed arcuate chamber walls have at least about a 120 degree arc length but less than a 180 degree arc length.

7. The flow meter of claim 1 wherein said at least one gear has at least three apexes radially spaced uniformly from one another by a predetermined number of degrees, and wherein said opposed arcuate chamber walls have an arc length approximately equal to the predetermined number of degrees.

8. The flow meter of claim 1 wherein both said inlet wall and said outlet wall are angled relative to the central axis.

9. The flow meter of claim 8 wherein said inlet wall has a different angle compared to said outlet wall.

10. The flow meter of claim 1 wherein said at least one gear includes two gears, wherein a first of said gears is positioned to seal against one of said chamber walls during rotation and a second of said gears is positioned to seal against the other of said chamber walls during rotation, and wherein said first and second gears seal against each other during rotation.

11. A flow meter comprising:
a chamber having opposed chamber walls;
at least one gear for rotation within said chamber, wherein said at least one gear is positioned to seal against a chamber wall during rotation;
an inlet in fluid communication with the chamber;
an outlet in fluid communication with the chamber;
wherein at least one of said inlet and said outlet is conically shaped such that it widens from a proximal portion to a distal portion, wherein said distal portion is in communication with said chamber.

12. The flow meter of claim 11 wherein said opposed chamber walls lie on an arc in the range from between 120° and 180°.

13. The flow meter of claim 11 wherein the distal portion of one of said inlet and outlet which is conically shaped forms a porting angle at the interface of said at least one conically shaped inlet and outlet with said chamber which is in the range from between about 15° and less than 90°.

14. The flow meter of claim 11 wherein both of said inlet and said outlet are conically shaped such that both widen from their respective proximal portions to their respective distal portions.
